(19) United States
(12) Patent Application Publication
(10) Pub. No.: US 2022/0097386 A1
(43) Pub. Date: Mar. 31, 2022

(54) LIQUID DISCHARGING APPARATUS

(71) Applicant: BROTHER KOGYO KABUSHIKI KAISHA, Nagoya (JP)

(72) Inventors: Fumio NAKAZAWA, Okazaki (JP); Yoshinori OSAKABE, Seto (JP); Taichi SHIRONO, Nagoya (JP); Sosuke KUROYANAGI, Nishio (JP)

(21) Appl. No.: 17/481,496

(22) Filed: Sep. 22, 2021

(30) Foreign Application Priority Data
Sep. 30, 2020 (JP) 2020-166538

(51) Int. Cl. B41J 2/175

(52) U.S. Cl. CPC B41J 2/175

(57) ABSTRACT

A liquid discharging apparatus, having a head, a reservoir section including a liquid reservoir chamber and an atmosphere communication path, a liquid flow path, a switching assembly, and a controller to control the switching assembly in a disconnecting process and the head in a discharging process after the disconnecting process, is provided. A volume of an air portion in the reservoir section is controlled to satisfy formulas: Vb=(Po+ΔP)*ΔV/ΔP and ΔP≤Pm. Po represents one atmosphere. AV represents a change in the volume of the air portion due to a change in a volume of the liquid caused by discharging a predetermined amount of liquid in the discharging process. AP represents a change in pressure of the air portion according to the change in the volume of the liquid in the discharging process. Pm represents a pressure resistance of menisci formed with the liquid in the nozzles.

### CROSS REFERENCE TO RELATED APPLICATION

This application claims priority under 35 U.S.C. § 119 from Japanese Patent Application No. 2020-166538, filed on Sep. 30, 2020, the entire subject matter of which is incorporated herein by reference.

### BACKGROUND

### Technical Field

The present disclosure relates to a liquid discharging apparatus capable of conducting a discharging action to discharge liquid at a sheet.

### Related Art

A liquid discharging apparatus, which may discharge liquid at a sheet, is known. The liquid to be discharged may be supplied from a reservoir section through a liquid supplying path and discharged from nozzles of a head at the sheet. The reservoir section may have an injection port, through which the liquid to refill may be injected, and an atmosphere communication path. During a discharging action by the head, the injection port may be closed by a lid. Meanwhile, during the discharging action, the liquid supplying path and the atmosphere communication path may be open to an outside atmosphere through a valve unit, which may operate in conjunction with a user's operations.

### SUMMARY

Occasionally, during the discharging action, a sheet may jam in the liquid discharging apparatus, and the jammed sheet may undesirably contact the head. The sheet contacting the head may cause the liquid to leak outside from the nozzles of the head and stain the sheet. In this regard, when the liquid supplying path and the atmosphere communication path are open during the discharging action, the air may keep entering the reservoir section through the atmosphere communication path as the liquid leaks out, and the liquid may continuously leak and spread to a larger extent.

In order to restrain leakage of the liquid to a smaller extent, it may be considered that the liquid supplying path and the atmosphere communication path should be closed. However, with the liquid supplying path and the atmosphere communication path being closed, as the discharging action continues, the air pressure in the reservoir section may decline shortly, depending on an amount of the liquid stored in the reservoir section. As a result, the liquid may not form menisci in the nozzles preferably during the discharging action, and the liquid may not be discharged correctly.

The present disclosure is advantageous in that a liquid discharging apparatus, in which leakage of liquid to a larger extent and liquid discharging failure that may occur during a discharging action may be restrained, is provided.

According to an aspect of the present disclosure, a liquid discharging apparatus, having a head, a reservoir section, a liquid flow path, a switching assembly, and a controller, is provided. The head has nozzles and is configured to discharge liquid through the nozzles. The reservoir section has a liquid reservoir chamber configured to store the liquid and an atmosphere communication path connecting inside and outside of the liquid reservoir chamber through an air portion in the reservoir section. The liquid flow path connects the head and the liquid reservoir chamber for the liquid to flow therein. The switching assembly is configured to switch states of the atmosphere communication path between a connecting state, in which the inside and the outside of the liquid reservoir chamber are connected, and a disconnecting state, in which the inside and the outside of the liquid reservoir chamber are disconnected. The controller is configured to control the switching assembly in a disconnecting process to switch the states of the atmosphere communication path from the connecting state to the disconnecting state; and control the head in a discharging process to discharge the liquid through the nozzles after the disconnecting process. A volume Vb of the air portion is set to satisfy formulas (1) and (2): Vb=(Po+ΔP)*ΔV/ΔP . . . (1); and ΔP≤Pm . . . (2). Po represents one atmosphere. ΔV represents a change in the volume of the air portion due to a change in a volume of the liquid caused by discharging a predetermined amount of the liquid in the discharging process. ΔP represents a change in pressure of the air portion according to the change in the volume of the liquid in the discharging process. Pm represents a pressure resistance of menisci formed with the liquid in the nozzles.

### BRIEF DESCRIPTION OF THE ACCOMPANYING DRAWINGS

FIG. 1 is an exterior perspective view of a printer 100 according to an embodiment of the present disclosure.

FIG. 2 is a cross-sectional view to illustrate an inner structure of the printer 100 according to the embodiment of the present disclosure.

FIG. 3 is a top plan view showing an area in the inner structure, including a reservoir section 220 and a neighboring structure, according to the embodiment of the present disclosure.

FIG. 4 is an illustrative view of the reservoir section 220 and the neighboring structure viewed from a front side, when a head 200 is located at a capped position P21, according to the embodiment of the present disclosure.

FIG. 5A is a rightward side view of the reservoir section 220 according to the embodiment of the present disclosure. FIG. 5B is an illustrative view of a vertical cross-section C1 of the reservoir section 220, sectioned at a dash-and-dot line VB-VB indicated in FIG. 5A and viewed from a front side, according to the embodiment of the present disclosure.

FIG. 6A is an illustrative view of a vertical cross-section C2 of the reservoir section 220, sectioned at a dash-and-dot line VI-VI indicated in FIG. 5A and viewed from the front side, according to the embodiment of the present disclosure. FIG. 6B is an illustrative view showing how to determine a volume Vb of an air portion in the reservoir section 220 according to the embodiment of the present disclosure.

FIG. 7 is an illustrative view of the reservoir section 220 and the neighboring structure when the head 200 is separated from the capped position P21 in the printer 100 according to the embodiment of the present disclosure.

FIG. 8 is a block diagram to illustrate functional blocks in the printer 100 according to the embodiment of the present disclosure.

FIGS. 9A-9B are flowcharts to illustrate steps in an image recording process to be conducted in the printer 100 according to the embodiment of the present disclosure.

FIG. 10A is an illustrative view of a vertical cross-section of the reservoir section 220 viewed from the front side according a second modified example of the embodiment of the present disclosure. FIG. 10B shows an execution timing table and a pointer to be stored in an EEPROM in the printer 100 according to the embodiment of the present disclosure.

FIGS. 11A-11B illustrate a modified example of an opener member 250, connecting and disconnecting an atmosphere communication path 221K, respectively, according to the embodiment of the present disclosure.

FIGS. 12A-12B illustrate a modified example of a cap 260 at a capping position P31 and an uncapping position P32, respectively, and a lift assembly 261 according to the embodiment of the present disclosure.

### DETAILED DESCRIPTION

### Embodiment

In the following paragraphs, with reference to the accompanying drawings, an embodiment of the present disclosure will be described. It is noted that various connections may be set forth between elements in the following description. These connections in general and, unless specified otherwise, may be direct or indirect and that this specification is not intended to be limiting in this respect.

In the following description, directivity indicated by a pointing arrow, from a root of a stem toward a pointing head, will be expressed by a term “orientation,” whereas back or forth movability along a line extending through a stem and a pointing head of an arrow will be expressed by a term “direction.”

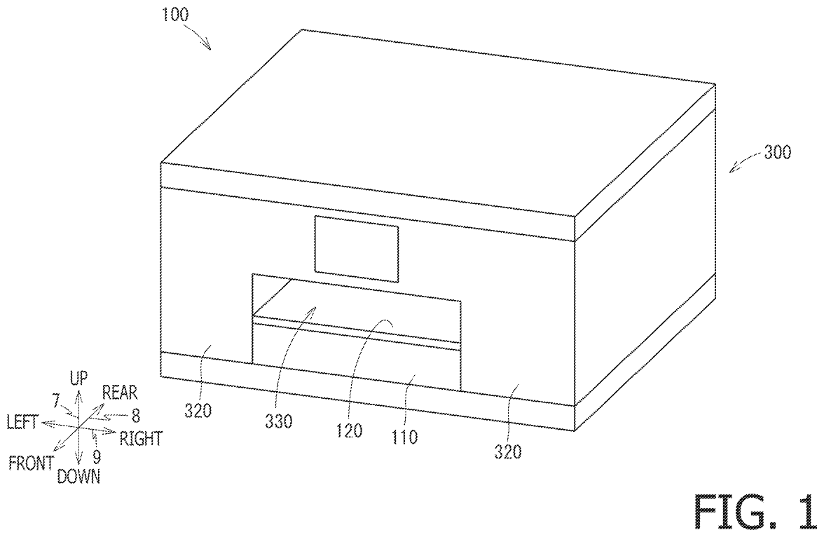

Moreover, positional relation within the printer 100 and each part or item included in the printer 100 will be mentioned on basis of a posture of the printer 100 in an ordinarily usable condition as indicated by the bi-directionally pointing arrows in FIG. 1. For example, a vertical axis between an upper side and a lower side in FIG. 1 is defined as an up-down direction 7. A side, on which an opening 330 is formed, is defined as a front face 320, and an axis between the front side and a rear side opposite from the front side is defined as a front-rear direction 8. A right-hand side and a left-hand side to a user who faces the front face 320 of the printer 100 are defined as a rightward side and a leftward side, respectively. An axis between the rightward side and the leftward side is defined as a right-left direction 9. The up-down direction 7, the front-rear direction 8, and the right-left direction 9 intersect orthogonally to one another. In the following description, the up-down direction 7 and the right-left direction 9 may be referred to as a vertical direction 7 and a widthwise direction 9, respectively.

[Overall Configuration of Printer 100]

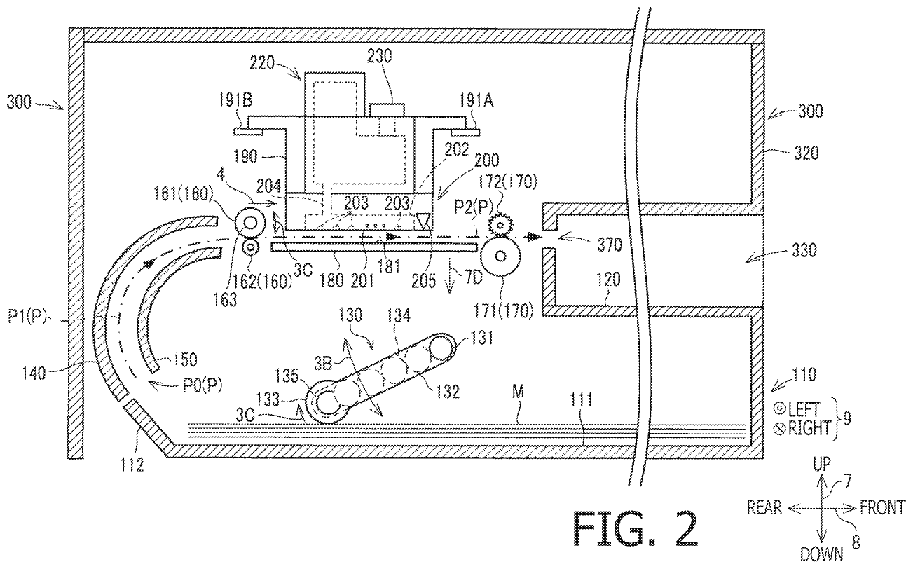

The printer 100 as shown in FIG. 1 may record a multicolored image in a plurality of, e.g., four (4), colors on a sheet M (see FIG. 2) in an inkjet recording method. The sheet M may be, for example, a sheet of paper or an OHP film. It may be noted, however, that the method to record the image on the sheet M may not necessarily be limited to inkjet recording but may be in a different recording method such as, for example, thermal-inkjet recording, which is also known as bubblejet (registered trademark) recording.

[Internal Configuration of Printer 100]

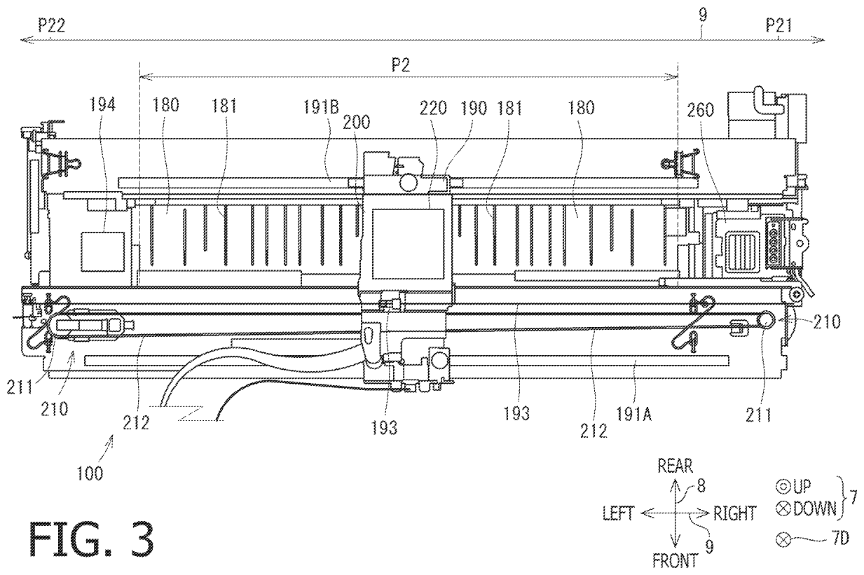

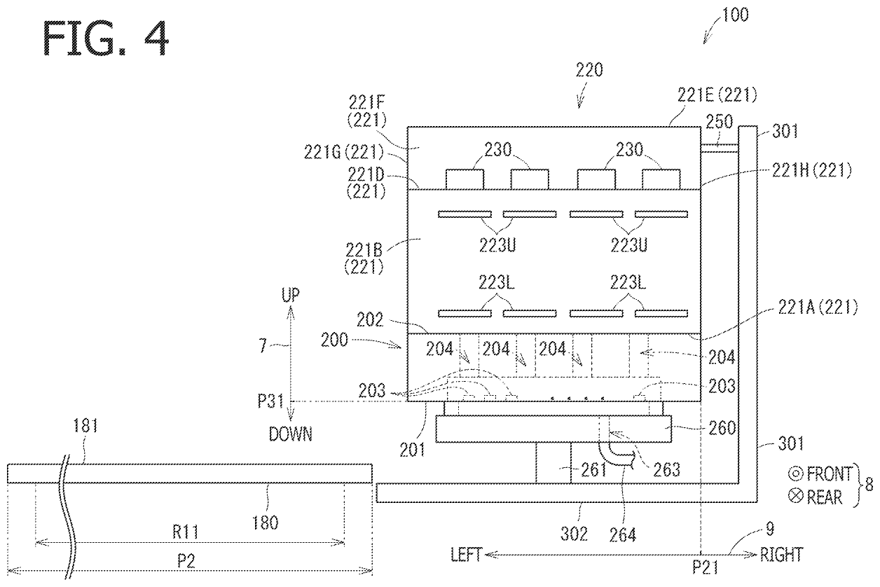

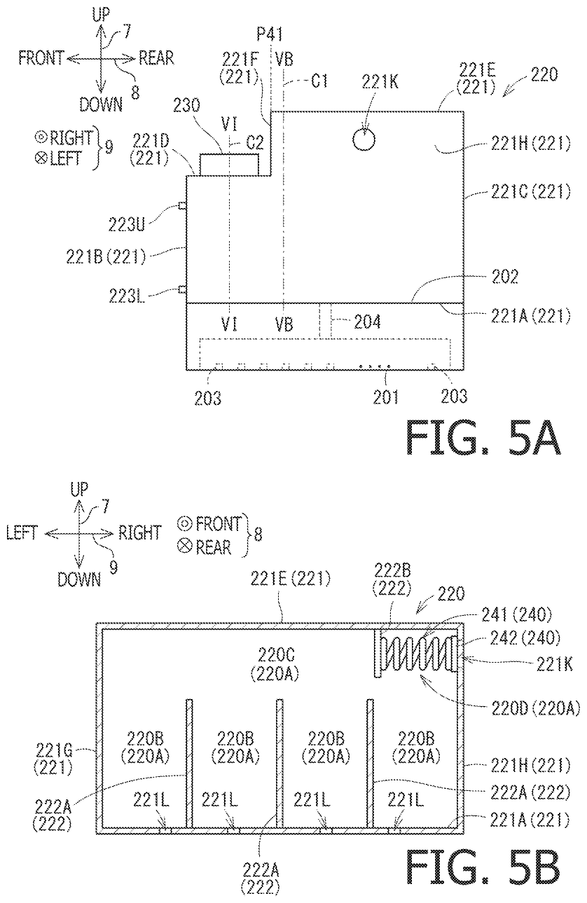

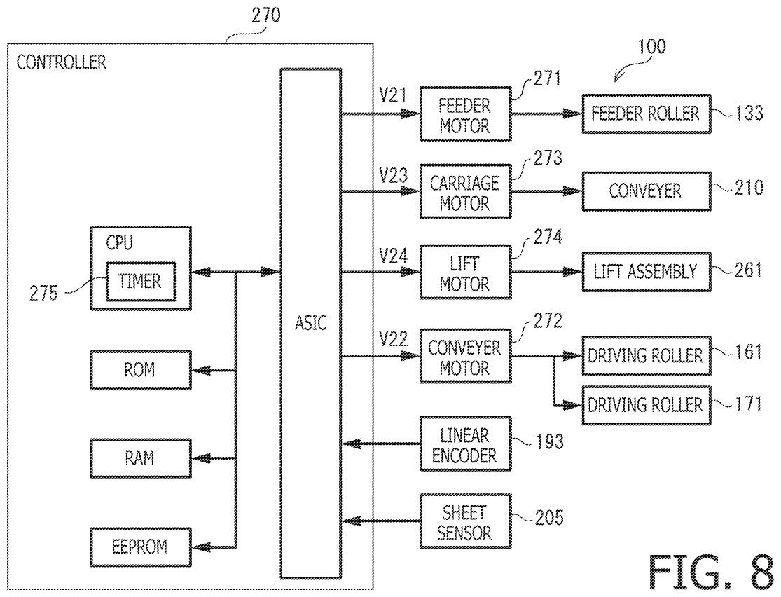

The printer 100 as shown in FIG. 2 has a feeder tray 110, an ejection tray 120, a feeder 130, an outer guide 140, an inner guide 150, a conveyer roller pair 160, an ejection roller pair 170, a platen 180, a carriage 190, a head 200, a conveyer 210 (see FIG. 3), the reservoir section 220, lids 230, a valve unit 240 (see FIG. 5B), an opener member 250 (see FIG. 4), a cap 260 (see FIG. 4), and a controller 270 (see FIG. 8), which are accommodated in a housing 300. At least the conveyer 210, the valve unit 240, and the opener member 250 may form a switching assembly, which will be described further below.

[Housing 300]

The housing 300 as shown in FIG. 1 may have a shape of an approximately rectangular cuboid. The housing 300 may be supported by frames, which are not shown, arranged inside. On the front face 320, the opening 330 being open frontward is formed.

[Feeder Tray 110]

The feeder tray 110 to store sheets M may be installed in the housing 300 through the opening 330. On a bottom 111 of the feeder tray 110, as shown in FIG. 2, one or more sheets M may be stacked in the vertical direction 7. From a rear end of the bottom 111, a guide member 112 extends upper-rearward to a position closely below a lower end of the outer guide 140.

[Ejection Tray 120]

In the housing 300, at a position above the feeder tray 110, a sheet outlet 370 is formed. Through the sheet outlet 370, the sheet M, on which an image is recorded in the printer 100, may be ejected. The sheet M with the image recorded thereon may be called as a printed material M. The ejection tray 120 is arranged at a lower-frontward position with respect to the sheet outlet 370. The ejection tray 120 may support the printed material M.

[Feeder 130]

The feeder 130 as shown in FIG. 2 includes a shaft 131, a feeder arm 132, a feeder roller 133, and a driving-force transmission assembly 134.

The shaft 131 is supported by a frame, which is not shown, and extends in the widthwise direction 9 at a position above the bottom 111. The feeder arm 132 is supported by the shaft 131 at a basal end part thereof. The feeder arm 132 is pivotable in a circumferential direction 3B of the shaft 131. The feeder arm 132 extends lower-rearward from the basal end part. The feeder roller 133 is attached to a tip end part of the feeder arm 132. The feeder roller 133 is rotatable in a circumferential direction 3C of a shaft 135, which is parallel to the shaft 131. The driving-force transmission assembly 134 may include a gear train and a driving belt and may be arranged inside the feeder arm 132.

Overall behaviors of the feeder 130 are herein described. The feeder roller 133 may contact an uppermost one of the sheets M stacked on the bottom 111 of the feeder tray 110. The driving-force transmission assembly 134 may transmit a force, generated by a feeder motor 271 (see FIG. 8) for feeding the sheets M, to the feeder roller 133. The feeder roller 133 may be rotated by the transmitted force and apply a rearward conveying force to the uppermost sheet M. Thereby, the uppermost sheet M may be conveyed rearward on the bottom 111 and guided by an inclined surface of the guide member 112 to a conveyer path P through a sheet inlet P0.

[Conveyer Path 1]

As shown in FIG. 2, inside the housing 300, the conveyer path P to convey the sheet M is formed. The sheet inlet P0 forms an upstream end of the conveyer path P and is arranged immediately above the extended end of the guide member 112. The conveyer path P is a so-called U-turn path and includes a curved path P1 and a linear path P2. The curved path P1 curves substantially upper-frontward from the sheet inlet P0. The linear path P2 extends substantially linearly frontward from a downstream end of the curved path P1 to the sheet outlet 370.

[Outer Guide 140, Inner Guide 150]

The outer guide 140 and the inner guide 150 delimit an outermost part and an innermost part of the curved path P1, respectively.

Conveyance of the sheet M is herein described. The sheet M fed to the sheet inlet P0 may be guided by the outer guide 140 and the inner guide 150 to be conveyed in the curved path P1. Thereafter, the sheet M may be passed to the conveyer roller pair 160.

[Conveyer Roller Pair 160]

The conveyer roller pair 160 includes a driving roller 161 and a pinch roller 162. The driving roller 161 and the pinch roller 162 are arranged to contact each other in the vertical direction 7 across a downstream end part of the curved path P1 and extend in the widthwise direction 9 along the downstream end part of the curved path P1. The driving roller 161 in the present embodiment contacts the pinch roller 162 from above. Optionally, however, the driving roller 161 may contact the pinch roller 162 from below.

The driving roller 161 may rotate by a force generated by a conveyer motor 272 (see FIG. 8) for conveying the sheets M. The pinch roller 162 may be rotated by the rotation of the driving roller 161. The driving roller 161 and the pinch roller 162 may nip the sheet M and rotate to convey the sheet M in a conveying orientation 4, e.g., frontward. Thereby, the sheet M may be conveyed downstream in the linear path P2.

[Ejection Roller Pair 170]

As shown in FIG. 2, the ejection roller pair 170 includes a driving roller 171 and a spur roller 172. The driving roller 171 and the spur roller 172 are located at a position between the platen 180 and the sheet outlet 370 in the linear path P2 across the linear path P2 to contact each other in the vertical direction 7 and extend in the widthwise direction 9 along the linear path P2. The spur roller 172 in the present embodiment contacts the driving roller 171 from above. Optionally, however, the spur roller 172 may contact the driving roller 171 from below.

The driving roller 171 may rotate by the force generated by the conveyer motor 272. The spur roller 172 may be rotated by the rotation of the driving roller 171. The driving roller 171 and the spur roller 172 may nip the sheet M and rotate to convey the sheet M further downstream in the conveying orientation 4. Thereby, the sheet M may be ejected outside through the sheet outlet 370.

[Platen 180]

The platen 180 is located between the conveyer roller pair 160 and the ejection roller pair 170 in the front-rear direction 8. The platen 180 has a supporting surface 181 spreading in the front-rear direction 8 and the widthwise direction 9. The supporting surface 181 delimits a lowermost part of the linear path P2 and may support the sheet M conveyed by the conveyer roller pair 160 from below. The supporting surface 181 may be formed of upper-end faces of a plurality of ribs protruding upward from the platen 180 and longitudinally extending in the front-rear direction 8. Optionally, however, the supporting surface 181 may be a plain upper surface of the platen 180.

[Carriage 190]

The printer 100 as shown in FIGS. 2-3 further has guide rails 191A, 191B arranged inside the housing 300. As shown in FIG. 2, the guide rails 191A, 191B are located at positions higher than the supporting surface 181 and are supported by a frame, which is not shown. In a top plan view, as shown in FIG. 3, the guide rails 191A, 191B are arranged to be spaced apart in the front-rear direction 8 to flank the supporting surface 181 and longitudinally extend in the widthwise direction 9. In other words, between the guide rails 191A, 191B in the front-rear direction 8, the supporting surface 181 of the platen 180 is located.

The carriage 190, as shown in FIG. 3, has a width smaller than a width of the platen 180 and is arranged over the guide rails 191A, 191B in the front-rear direction 8. The carriage 190 may move on the guide rails 191A, 191B by the force transmitted through the conveyer 210 to reciprocate in the widthwise direction 9. In the following paragraphs, the direction in which the carriage 190 is movable may be called as a scanning direction 9.

[Head 200]

The head 200 as shown in FIG. 2 has a lower face 201, an upper face 202, a plurality of nozzles 203, and ink flow paths 204. The plurality of nozzles 203 are formed to align along the front-rear direction 8 and the widthwise direction 9 on the lower face 201. In FIG. 2, among the plurality of nozzles 203, merely nozzles 203 aligning along the front-rear direction 8 are shown. Each nozzle 203 has a downward discharging opening. The head 200 is mounted on the carriage 190 so that the lower face 201 of the head 200 may move in the scanning direction 9 along with the carriage 190 in a position separated above from the supporting surface 181. In this regard, the lower face 201 delimits an uppermost part of the linear path P2.

The head 200 accommodates piezoelectric devices (not shown), which correspond to the nozzles 203 on one-to-one basis. Driving waveforms modulated by the controller 270 may be applied to the piezoelectric devices in the head 200, and thereby the head 200 may discharge the ink and consume the ink stored therein through the nozzles 203 in a discharging orientation 7D, i.e., downward.

[Conveyer 210 (A Part of Switching Assembly)]

The conveyer 210 as shown in FIG. 3 includes two (2) pulleys 211 and an endless belt 212. The conveyer 210 forms a part of the switching assembly and may switch states of a valve body 242, which will be described further below, between an opening state and a closing state. The pulleys 211 are separated on the guide rail 191A from each other in the widthwise direction 9. Each pulley 211 may rotate in a circumferential direction of an axis thereof, which extends along the vertical direction 7. The endless belt 212 is strained around the pulleys 211 and is coupled to the carriage 190. One of the pulleys 211, e.g., the pulley 211 on the right, is coupled to a carriage motor 273 (see FIG. 8) for driving the carriage 190. The carriage motor 273 may operate under control of the controller 270 and generate a driving force. The pulley 211 on the right may be driven by the driving force from the carriage motor 273 to rotate in either a normal direction or a reverse direction. Therefore, the head 200 coupled to the endless belt 212 may reciprocate in the widthwise direction 9 between a capped position P21 and a flushing position P22, which are set in advance between the pulleys 211. The capped position P21 may be at substantially the same position in the widthwise direction 9 as the cap 260, which is separated rightward from the platen 180 and leftward from a frame 301 (see FIG. 4). The flushing position P22 is separated leftward from the platen 180. An ink receiver 194 is arranged at the flushing position P22.

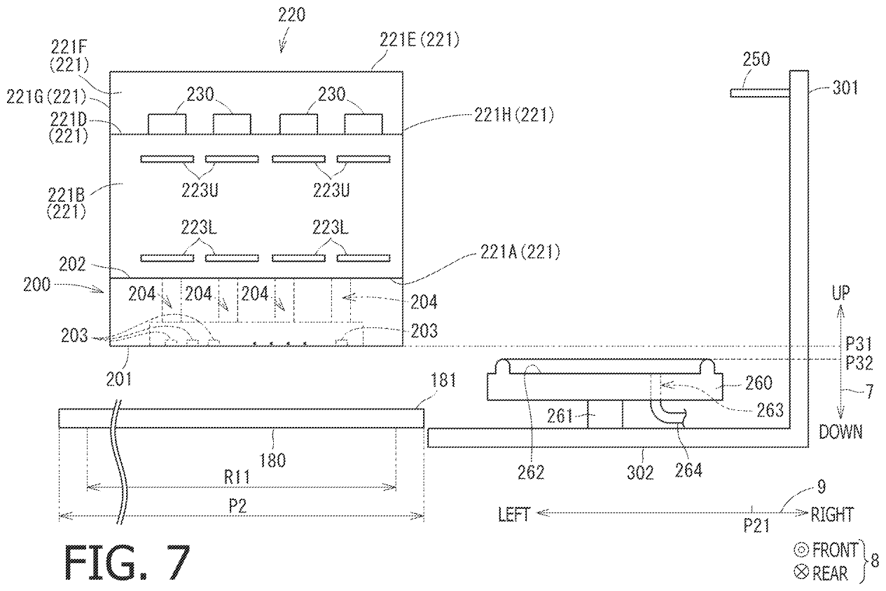

The head 200 may move above an ink dischargeable range R11 (see FIG. 7), which will be described further below, while the carriage 190 moves leftward or rightward in a swath or a pass under the control of the controller 270. The head 200 and the ink reservoir chamber 220B are connected through the ink flow paths 204 allowing the liquid to flow therein. While moving in the widthwise direction 9, the head 200 may discharge the inks supplied through the ink flow paths 204 from the reservoir section 220. In other words, a line of image for a pass may be recorded on the sheet M.

[Reservoir Section 220, Lids 230]

The reservoir section 220 being an ink tank is attached to the upper face 202 of the head 200, as shown in FIGS. 4, 5A, and 6B, so that the reservoir section 220 may not be detached from the head 200 easily. In other words, the printer 100 in the present embodiment may be a so-called on-carriage printer, in which the reservoir section 220 and the head 200 are mounted on the carriage 190 (see FIG. 3). The reservoir section 220 may be located entirely at an upper position with respect to the head 200. Optionally, however, the reservoir section 220 may be at least partly located above the upper face 202 of the head 200, and another part of the reservoir section 220 may be located below the upper face 202 of the head 200.

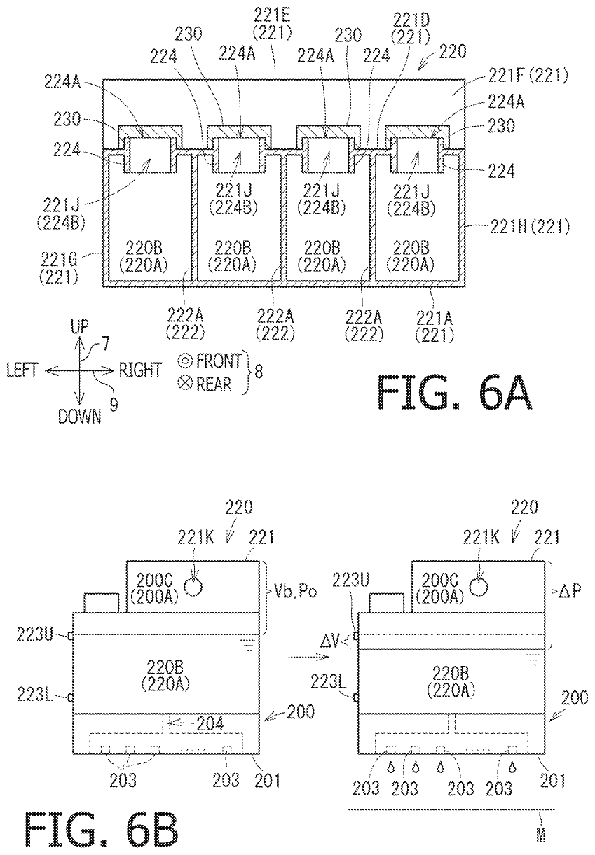

The reservoir section 220 has, as shown in FIGS. 4 and 5A, an outer wall 221, four (4) upper indexes 223U, four (4) lower indexes 223L, and four (4) lids 230. Moreover, the reservoir section 220 has, as shown in FIG. 6A, a plurality of divider walls 222 and a cylindrical wall 224.

As shown in FIGS. 5B and 6A-6B, the outer wall 221 delimits an inner space 220A of the reservoir section 220 from an external surrounding. The reservoir section 220 may be mainly made of a translucent material, e.g., transparent resin. Therefore, a user may visually recognize amounts of the inks stored in the reservoir section 220.

As shown in FIGS. 4, 5A-5B, and 6A, the outer wall 221 includes a bottom wall 221A, a first front wall 221B, a rear wall 221C, a first upper wall 221D, a second upper wall 221E, a second front wall 221F, a left-side wall 221G, and a right-side wall 221H. The bottom wall 221A, the first upper wall 221D, and the second upper wall 221E are in substantially rectangular forms in a plan view along the vertical direction 7. The first front wall 221B, the second front wall 221F, and the rear wall 221C are substantially in rectangular forms in a view along the front-rear direction 8.

The bottom wall 221A spreads on the upper face 202 of the head 200. A frontward edge and a rearward edge of the bottom wall 221A are substantially parallel to the front-rear direction 8.

The first front wall 221B and the rear wall 221C extend upward from the front edge and the rear edge of the bottom wall 221A, respectively. An extended end, i.e., an upper end, of the first front wall 221B is located to be lower than an extended end of the rear wall 221C.

The first upper wall 221D spreads between the upper end of the first front wall 221B and an intermediate position P41 (see FIG. 5A), which is between the first front wall 221B and the rear wall 221C. The second upper wall 221E spreads between an upper end of the rear wall 221C and the intermediate position P41.

In the first upper wall 221D, as shown in FIG. 6A, four (4) through holes 221J, through which the ink may be injected into the reservoir section 220, are formed through the first upper wall 221D in the vertical direction 7.

As shown in FIGS. 4 and 5A, the second front wall 221F spreads between a rear edge of the first upper wall 221D and a front edge of the second upper wall 221E.

The left-side wall 221G and the right-side wall 221H, as shown in FIG. 4, close the leftward end and the rightward end of the reservoir section 220, respectively.

Next, the plurality of divider walls 222 will be described with reference to FIGS. 5B and 6A. FIG. 5B shows a vertical cross-section C1 of the reservoir section 220, sectioned at a dash-and-dot line VB-VB indicated in FIG. 5A. FIG. 6A shows a vertical cross-section C2 of the reservoir section 220, sectioned at a dash-and-dot line VI-VI indicated in FIG. 5A. The vertical cross-sections C1, C2 are both parallel to the vertical direction 7 and to the widthwise direction 9. The vertical cross-section C1 spreads from the second upper wall 221E to the bottom wall 221A, and the vertical cross-section C2 spreads from upper ends of the lids 230 to the bottom wall 221A.

The plurality of divider walls 222 include three (3) vertical divider walls 222A and a vertical divider wall 222B, which delimit the inner space 220A, together with the outer wall 221, into four (4) ink reservoir chambers 220B, an air chamber 220C, and a valve placement space 220D.

The vertical divider walls 222A align spaced apart from one another in the widthwise direction 9 in the inner space 220A. In particular, the vertical divider walls 222A extend upward from the bottom wall 221A at different positions and spread in the front-rear direction 8 and the vertical direction 7. Each of the vertical divider walls 222A is connected to the first upper wall 221D (see FIG. 6A) at a position between two adjoining through holes 221J in the widthwise direction 9. Meanwhile, none of the vertical divider walls 222A is connected to the second upper wall 221E (see FIG. 5B). In other words, the extended ends of the vertical divider walls 222A are separated below from the second upper wall 221E. Each vertical divider wall 222A is connected to the first front wall 221B at a front end thereof and to the rear wall 221C at a rear end thereof. None of the vertical divider walls 222A is connected to the second front wall 221F.

The vertical divider wall 222B extends downward from the second upper wall 221E at a position separated leftward from the right-side wall 221H and spreads in the vertical direction 7 and the front-rear direction 8. The vertical divider wall 222B extends in the vertical direction 7 to a position separated above from the extended ends of the vertical divider walls 222A.

The four ink reservoir chambers 220B are spaces enclosed by the bottom wall 221A, the first front wall 221B, the rear wall 221C, the first upper wall 221D, the left-side wall 221G, the right-side wall 221H, the three vertical divider walls 222A. The four ink reservoir chambers 220B may store inks in four (4) different colors (e.g., yellow, magenta, cyan, and black). Each ink reservoir chamber 220B is connectable with the outside of the reservoir section 2210 through a corresponding one of the through holes 221J.

The air chamber 220C is a space enclosed by the second front wall 221F, the rear wall 221C, the second upper wall 221E, the left-side wall 221G, and the right-side wall 221H. The air chamber 220C is located at an upper position with respect to the upper indexes 223U. The air chamber 220C may store at least a part of the air, i.e., an air portion, in the reservoir section 220. Optionally, the air chamber 220C may be enclosed by another divider wall(s) or may be a so-called labyrinth flow path.

As shown in FIG. 5B, the valve placement space 220D is a space delimited by the second upper wall 221E, the right-side wall 221H, and the vertical divider wall 222B and accommodates the valve unit 240. A lower side of the valve placement space 220D is open downward. Therefore, the valve placement space 220D is continuous with the ink reservoir chambers 220B through the air chamber 220C.

The upper indexes 223U, as shown in FIG. 4, are arranged on an outer surface of the first front wall 221B at a position in proximity to the upper edge of the first front wall 221B. Each of the upper indexes 223U is arranged on a front side of a corresponding one of the ink reservoir chambers 220B. The upper indexes 223U are located at a same position in the vertical direction 7 and spaced apart from one another to align in the widthwise direction 9.

The lower indexes 223L are arranged on the outer surface of the first front wall 221B at a position lower than the upper indexes 223U. Each of the lower indexes 223L is arranged at a lower position with respect to a corresponding one of the upper indexes 223U. The lower indexes 223L are located at a same position in the vertical direction 7 and spaced apart from one another to align in the widthwise direction 9.

Each of the upper indexes 223U and the lower indexes 223L has a linear form extending in the widthwise direction 9. The upper indexes 223U and the lower indexes 223L may be marked on the outer surface of the first front wall 221B by engraving, embossing, or painting in a colorant. Each of the upper indexes 223U is a sign indicating a surface level of a maximum amount of the ink storable in the ink reservoir chambers 220B that are behind the upper indexes 223U. Each of the lower indexes 223L is a sign indicating a surface level of the ink, at which the ink reservoir chamber 220B should be refilled with the ink.

As shown in FIG. 6A, the cylindrical walls 224 cylindrically extend upward and downward from circumferential edges of the through holes 221J in the first upper wall 221D. Each cylindrical wall 224 has an injection port 224A at an upper end thereof. In other words, an upper end of each cylindrical wall 224 forms an injection port 224A. The injection port 224A is an opening which is open upward, or outward, from the reservoir section 220. An inner circumferential surface of each cylindrical wall 224 delimits an ink supplying path 224B, which continues from the injection port 224A through the through hole 221J to the ink reservoir chamber 220B. In other words, the injection port 224A is continuous with the ink reservoir chamber 220B, and the ink supplying path 224B connects the inside and the outside of the ink reservoir chamber 220B. Lower ends of the ink supplying paths 224B are located to be lower than the air chamber 220C. In other words, the air chamber 220C is located at an upper position with respect to the lower ends of the ink supplying paths 224B.

The lids 230 shown in FIGS. 4, 5A, and 6A may be formed of, for example, flexible resin. The lids 230 are attachable to and detachable from upper ends of the cylindrical walls 224 by the user to close and open the injection ports 224A.

As shown in FIGS. 5A-5B, an atmosphere communication path 221K is formed in the right-side wall 221H at a position coincident with the vertical divider wall 222B in the widthwise direction 9. The atmosphere communication path 221K is a through hole formed through the right-side wall 221H in the widthwise direction 9. The atmosphere communication path 221K connects the ink reservoir chambers 220B and the outside of the reservoir section 220 through the valve placement space 220D and the air chamber 220C.

In the bottom wall 221A, four (4) outflow ports 221L are formed at positions coincident with lower ends of the four ink reservoir chambers 220B. Each of the outflow ports 221L are through holes formed vertically through the bottom wall 221A and are continuous with a corresponding one of the ink flow paths 204. Through the outflow ports 221L, the inks in the ink reservoir chambers 220B may be supplied to the head 200. In the present embodiment, the air chamber 220C is entirely located to be higher than the outflow ports 221L. Optionally, however, the air chamber 220C may be at least partly located at an upper position with respect to the outflow port 221L.

[Valve Unit 240, Opener member 250 (Part of Switching Assembly)]

As shown in FIG. 5B, the valve unit 240 has a spring 241 and the valve body 242.

The spring 241 may be a compressive coil spring, of which natural length is substantially equal to or larger than a distance between the right-side wall 221H and the vertical divider wall 222B in the widthwise direction 9. The spring 241 is accommodated in the valve placement space 220D with an axis thereof aligning in parallel with the widthwise direction 9. A leftward end of the spring 241 is fixed to the vertical divider wall 222B. To a rightward end of the spring 241, the valve body 242 is fixed.

The valve body 242 may, when the opener member 250 is not contacting the valve body 242, with an inner surface of the right-side wall 221H serving as a valve seat, close the atmosphere communication path 221K by an urging force of the spring 241. Thereby, the atmosphere communication path 221K is placed in a disconnecting state, in which the ink reservoir chambers 220B and the outside of the reservoir section 220 are disconnected.

A frame 301, as shown in FIG. 4, is arranged inside the housing 300. The frame 301 extends in the vertical direction 7 at a position separated rightward from the cap 260 and faces the right-side wall 221H of the reservoir section 220 in the widthwise direction 9. The opener member 250 protrudes leftward from the frame 301 at a position coincident with the atmosphere communication path 221K (see FIGS. 5A-5B) in the widthwise direction 9. A cross-sectional area of the opener member 250 at a section along the vertical direction 7 and the front-rear direction 8 is smaller than the opening of the atmosphere communication path 221K throughout an entire range in the widthwise direction 9. A length of the opener member 250 in the widthwise direction 9 is greater than a distance between the valve body 242 when the head 200 is at the capped position P21 and the frame 301. When the carriage 190 moves in the widthwise direction 9, and shortly before the head 200 on the carriage 190 reaches the capped position P21, a protrusive end of the opener member 250 may enter the atmosphere communication path 221K and contact the valve body 242. While the head 200 stays in the capped position P21, the valve body 242 is separated from the right-side wall 221H by a contacting force from the opener member 250 against the urging force of the spring 241. Therefore, the valve body 242 may open the atmosphere communication path 221K. In other words, the opener member 250 may switch the valve body 242 from the closing state to the opening state. Thus, the valve body 242 may switchably open and close the atmosphere communication path 221K. Accordingly, the atmosphere communication path 221K may be placed in a connecting state, in which the ink reservoir chambers 220B and the outside of the reservoir section 220 are connected to communicate.

[Cap 260]

As shown in FIGS. 4 and 7, the cap 260 is located at a position substantially same as the head 200 in the front-rear direction 8 and has an approximately rectangular-boxed shape in a top plan view. An upper end of the cap 260 is open upward. The cap 260 may be formed of an elastic material such as rubber.

The cap 260 is supported by a frame 302, which spreads in the front-rear direction 8 and the widthwise direction 9, through a lift assembly 261. The lift assembly 261 may move the cap 260 vertically between a capping position P31 and an uncapping position P32 by a driving force generated under control of the controller 270 by a lift motor 274 (see FIG. 8). The capping position P31 is a position, at which the upper end of the cap 260 contacts the lower face 201 of the head 200 being located at the capped position P21, as shown in FIG. 4. The cap 260 at the capping position P31 may cover the nozzles 203 formed in the lower face 201 of the head 200. The uncapping position P32 is lower than the capping position P31 and is a position, at which the upper end of the cap 260 is separated from the lower face 201 of the head 200, as shown in FIG. 7.

On a bottom 262 of the cap 260, a plurality of through holes 263 are formed, although in FIGS. 4 and 7 solely one of the through holes 263 is shown. To each of the through holes 263, a tube 264 is connected at one end so that the through hole 263 and the tube 264 are in fluid communication. The other end of the tube 264 is connected to a pump, which is not shown. The pump may be activated by the controller 270 when the cap 260 is at the capping position P31. Accordingly, obstacles and the ink remaining in the head 200 may be vacuumed and collected on the cap 260. The collected obstacles on the cap 260 may be transported through the tubes 264 to a waste tank, which is not shown.

[Volume Vb of Air Portion]

Next, with reference to FIG. 6B, a volume Vb of an air portion will be described. The air portion is a part of the inner space 220A, i.e., a cavity, not occupied by the inks. The volume Vb is a volume of the air portion when surfaces of the inks are at the substantially same vertical position as the upper indexes 223U. The volume Vb may be determined while being designed by a manufacturer in a following manner.

While the valve body 242 (see FIG. 5B) closes the atmosphere communication path 221K, in other words, while the atmosphere communication path 221K is in the disconnecting state, a discharging process may be conducted under the control of the controller 270. The discharging process is a process, in which the head 200 discharges the inks at the sheet M on the supporting surface 81 to record a specific image based on specific image data under a specific condition. This discharging process will be described further below. During the discharging process, as the time proceeds, with the atmosphere communication path 221K in the disconnecting state, the inks in the ink reservoir chambers 220B may be consumed, and the volume of the air portion may increase; therefore, the air pressure in the air portion may decrease.

Meanwhile, the printer 100 may conduct a flushing action before or during the image is recorded on the sheet M in the discharging process. In particular, the head 200 may, under the control of the controller 270, discharge the inks through the nozzles 203 at the ink receiver 194. Therefore, the volume of the air portion may increase even more by the flushing action, and the air pressure in the air portion may decrease, as the time proceeds. In the present embodiment, the discharging process includes acts of the controller 270 for the flushing action.

In this regard, duration of the discharging process may be a factor to change the air pressure in the reservoir section 220.

In the present embodiment, the air pressure of the air portion in the reservoir section 220 when the atmosphere communication path 221K is in the disconnecting state, i.e., one atmosphere (1 atm), may be represented by a sign Po. While a change in the volume of the air portion due to a change in volumes of the inks caused by the discharging process may be represented by a sign ΔV, and a change in the pressure of the air portion may be represented by a sign ΔP, the volume Vb is controlled to satisfy a formula: Vb=(Po+ΔP)*ΔV/ΔP . . . (1).

Moreover, while a pressure resistance of the menisci formed with the inks in the nozzles 203 may be represented by a sign Pm, ΔP satisfies a formula: ΔP≤Pm . . . (2).

The pressure resistance Pm may be predetermined based on the specifications of the inks and the head 200. In order to calculate the pressure resistance Pm of the ink menisci, surface tension of the authentic inks provided by the manufacturer or distributor of the printer 100 and the contact angle with the authentic inks may be used. In particular, if a diameter of each nozzle 203 is d, the surface tension of the inks may be represented by a sign σ, and the contact angle of the inks at the lower face 201 of the nozzles 203 may be represented by a sign θ, Pm may be obtained from a formula: Pm=4*σ*cos θ/d . . . (3). Meanwhile, the diameter d of the nozzle 203 may be based on an exit diameter of the nozzle 203.

The surface tension 6 may be obtained, for example, by the Wilhelmy method. The contact angle θ may be the contact angle when an ink is dropped on the lower face 201, which is the flat ink discharge surface, and may be obtained by, for example, the θ/2 method.

The specific image is a multicolor pattern image defined in ISO/IEC 24734, which is established by the International Organization for Standardization. The color pattern image is an image defined in ISO/IEC 24734, and is described in image data in a predetermined data format (doc format, xls format, pdf format, etc.).

The specific condition is recording the specific image continuously for 30 seconds on a sheet in A4-size in the standard mode defined in ISO/IEC 24734. The specific condition includes, in particular, a resolution (CR×LF) and a margin size. The resolution may be, for example, 600×300 dpi. In a case of the doc format, the margin size is 34.3 mm on each of the top and the bottom, and 29.2 mm on each of the left and the right sides of the sheet. In a case of the xls format, the margin size is 3 mm on each of the top and the bottom, and 3 mm on each of the left and the right sides of the sheet.

[Controller 270]

As shown in FIG. 8, the controller 270 includes a CPU, a ROM, a RAM, an EEPROM, and an ASIC, which are mutually connected through internal buses. The ROM may store programs to control the operations in the printer 100. The CPU may run the programs with use of the RAM and the EEPROM.

The ASIC is electrically connected with the motors 271-274. The ASIC may generate and output controlling signals V21, V22, V23, V24 to rotate the feeder motor 271, the conveyer motor 272, the carriage motor 273, and the lift motor 274, respectively.

The controller 270 has a total consumed amount counter for each of the four colored inks in, for example, the EEPROM. The total consumed amount counters may be used to cumulatively estimate consumed ink amounts in the reservoir section 220. The cumulation by the total consumed amount counters may start immediately after an ink injecting process.

The controller 270 has a timer 275 as an internal circuit of the CPU. The timer 275 may, according to an instruction from the CPU, accumulate a time length from a point when a start command is input to a point when a stop command is input as duration. When the duration reaches a predetermined time threshold value, the timer 275 returns a response indicating the reach to the CPU. The time threshold value is set to a time length shorter than a time length that may cause the menisci in the nozzles 203 to collapse due to the increased negative pressure in the inner space 220A. The time length that may cause the menisci in the nozzles 203 to collapse may be determined in advance while the printer 100 is being designed by the manufacturer through, for example experiments. In the present embodiment, the time threshold value is 30 seconds, or may be a time length including 30 seconds and an allowance.

[Image Recording Process by Controller 270]

When the printer 100 is standing by for image recording, the head 200, the cap 260, and the valve unit 240 are at positions shown in FIG. 4. In this arrangement, the head 200 is standing by at a home position, which may be, in the present embodiment, the capped position P21. Meanwhile, the capped position P21 may also be an origin point, from which the head 200 starts moving in the widthwise direction 9. Optionally, however, the home position may be any position between the platen 180 and the cap 260 in the widthwise direction 9 or may be at a position rightward with respect to the cap 260. The cap 260 stays at the capping position P31 and covers the nozzles 203 of the head 200. The valve body 242 is subject to the contacting force of the opener member 250 and opens the atmosphere communication path 221K to place the atmosphere communication path 221K in the connecting state. The lids 230 close the injection ports 224A (see FIG. 6A).

When the printer 100 is standing by or running an image recording process, the controller 270 may receive a print job and store the received print job in, for example, the RAM. A sender of the print job may be a personal computer or a smartphone which may communicate with the printer 100. The print job is an execution command for an image recording process and includes at least image data and setting information. The image data describes an image to be recorded in the image recording process. The image data may describe an image to be recorded on a single sheet M or a plurality of images to be recorded on a plurality of sheets M. The setting information describes settings for the image recording process including, for example, a print mode, a size of the sheet(s) M, margins on the sheet(s) M, and resolutions of the image(s). It may be noted that the size of the sheet(s) M, the margins on the sheet(s) M, and the resolution(s) of the image(s) are explained earlier.

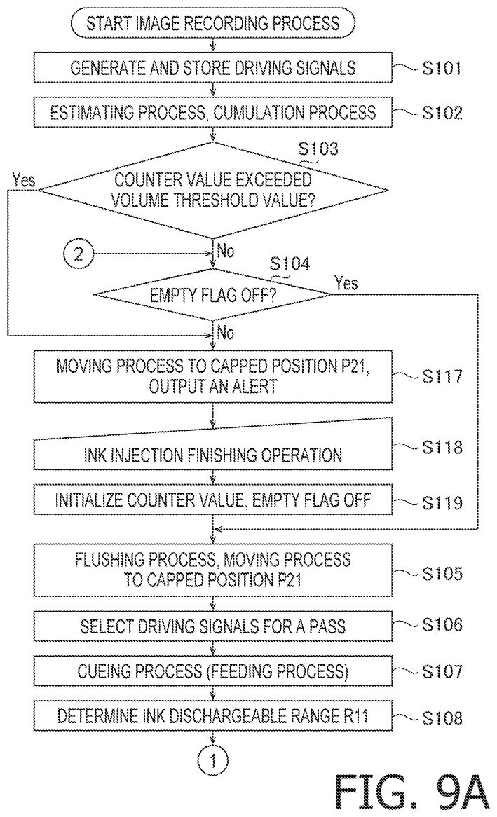

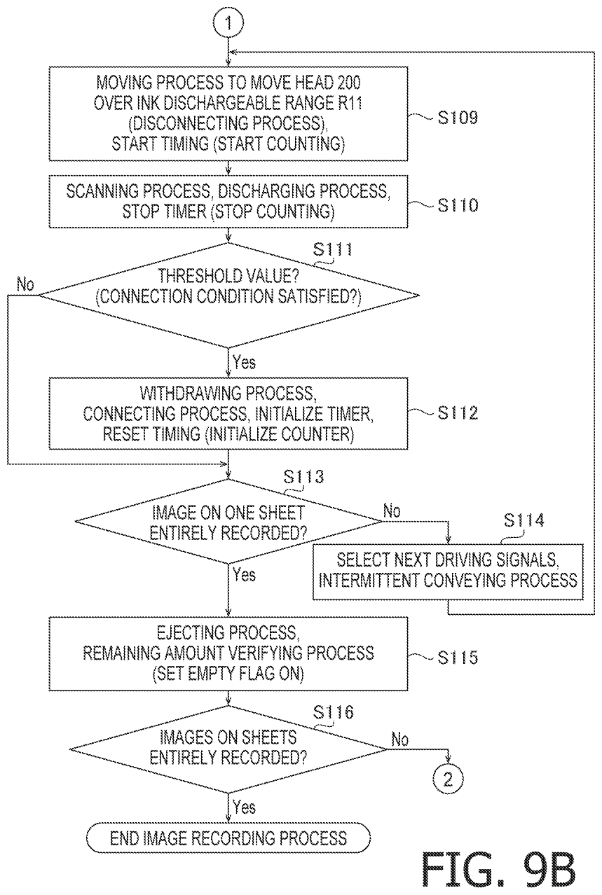

The controller 270 may select one of print jobs stored in the RAM and start an image recording process (see FIGS. 9A-9B) based on the selected print job.

As shown in FIG. 9A, in S101, the controller 270 generates driving signals in the RAM based on the image data and the setting information. The driving signals may be used for driving the piezoelectric devices in the head 200 and are generated for the entire passes that are required to record the image described in the image data for each of the different-colored inks.

In S102, the controller 270 conducts an estimating process and a cumulation process for estimated total consumable amounts of the inks. The estimated total consumable amount is an amount of each ink to be consumed by the head 200 with the piezoelectric devices driven by the entire driving signals generated in S101. Moreover, in S102, the controller 270 adds the estimated total consumable amounts of the inks to the counter values in the respective total consumed amount counters.

In S103, the controller 270 determines whether any of the current counter values exceeds a volume threshold value. The volume threshold value indicates a predetermined amount of the ink storable in the ink reservoir chamber 220B between the lower index 223L and the upper index 223U. In the present embodiment, the volume threshold values for the four inks are the same. When the controller 270 determines that any of the current counter values exceeds the volume threshold value, the controller 270 proceeds to S117. When the controller 270 determines that none of the current counter values exceeds the volume threshold value, the controller 270 proceeds to S104.

In S104, the controller 270 determines whether an empty flag in the RAM or the EEPROM is off. The empty flag may be set off after an ink injecting process (S117-S119), which will be described further below. The empty flag may be set on in a remaining amount verifying process in S115 (see FIG. 9B), which will be described further below. When the empty flag is off, the controller 270 proceeds to S105; but when the empty flag is on, the controller 270 proceeds to S117.

In S105, the controller 270 conducts a flushing process. In particular, as an earlier step in the flushing process, the controller 270 conducts a separating step, in which the controller 270 outputs the controlling signals V24 to control the lift assembly 261 through the lift motor 274 to lower the cap 260 from the capping position P31 to the uncapping position P32 (see FIG. 7).

As a latter step in the flushing process, the controller 270 moves the head 200 in the widthwise direction 9 to the flushing position P22. In particular, the controller 270 outputs the controlling signals V23 to the carriage motor 273 to control the conveyer 210 to move the carriage 190 in the widthwise direction 9. While the carriage 190 is being moved, the controller 270 determines an updated position of the head 200 based on signals output from a linear encoder 193 (see FIG. 3). Until the updated position matches the flushing position P22, the controller 270 continues moving the head 200 in the widthwise direction 9 toward the flushing position P22. When the updated position of the head 200 matches the flushing position P22, the controller 270 stops the head 200 at the flushing position P22 and controls the head 200 staying over the ink receiver 194 to discharge the ink at the ink receiver 194. The flushing process is thus conducted. During the flushing process, the controller 270 activates the timer 275 to count the time between the start of discharging the inks from the head 200 and the end of the discharging.

After the flushing process, further in S105, the controller 270 conducts a moving process, in which the controller 270 outputs the controlling signals V23 to the carriage motor 273 and moves the head 200 from the flushing position P22 to the home position, i.e., the capped position P21. Meanwhile, the controller 270 monitors updated positions of the head 200 periodically and, when the updated position matches the capped position P21, the controller 270 stops outputting the controlling signals V23. The process in S105 ends thereat.

In S106, the controller 270 selects a unit of the driving signals stored in the RAM for a pass to be run in a discharging process in S110 (see FIG. 9B).

In S107, the controller 270 conducts a cueing process and controls one of the sheets M in the feeder tray 110 to be conveyed to a cueing position, which is a position in the linear path P2 straight below the sheet sensor 205 (see FIG. 2). The sheet sensor 205 may be arranged at a position in proximity to a front end of the lower face 201. The sheet sensor 205 being an optical sensor is arranged to face the supporting surface 181 of the platen 180.

In the cueing process, in particular, the controller 270 outputs the controlling signals V21 to the feeder motor 271 to control the feeder roller 133 to convey the sheet M in the curved path P1. Thereafter, the controller 270 outputs the controlling signals V22 to the conveyer motor 272 to control the conveyer roller pair 160 to convey the sheet M to the cueing position in the linear path P2. While outputting the controlling signals V22, the controller 270 obtains signals from the sheet sensor 205 periodically and stops outputting the controlling signals V22 in response to a change of levels of the obtained signals. Thus, the sheet M may pause on the supporting surface 181 with a frontward edge of the sheet M located at the cueing position.

In S108, the controller 270 determines an ink dischargeable range R11 (see FIG. 4) based on the size of the sheet M and the margin size contained in the setting information in the print job. The ink dischargeable range R11 is a range, in which the ink may be discharged at the sheet M on the supporting surface 181, and is a remainder of subtracting the margin size from each side of the sheet M.

In S109 (see FIG. 9B), the controller 270 outputs the controlling signals V23 to the carriage motor 273 to move the head 200 from the capped position P21 to a position straight above a discharge-start position in the ink dischargeable range R11. The discharge-start position is an initial position for the head 200 when an image for a single pass is to be recorded on the sheet M on the supporting surface 181.

Before S109, in other words, when the head 200 is located at the capped position P21, as shown in FIG. 4, the atmosphere communication path 221K is in the connecting state. From this position, while the head 200 moves from the capped position P21 to the position above the ink dischargeable range R11 in S109, the valve body 242 separates from the opener member 250 and closes the atmosphere communication path 221K by the urging force of the spring 241 (see FIG. 7). Therefore, the atmosphere communication path 221K is shifted to the disconnecting state. In other words, in S109, the switching assembly may place the atmosphere communication path 221K in the disconnecting state.

In S109, moreover, the controller 270 conducts a measure-start process. In particular, as the controller 270 starts outputting the controlling signals V23, in other words, as the head 200 starts moving from the capped position P21, the controller 270 conducts the measure-start process, in which the controller 270 activates the timer 275 to start measuring time.

In S110, the controller 270 conducts a conveying process, in which the head 200 is conveyed in the scanning direction 9, i.e., the widthwise direction 9, and a discharging process. The conveying process to convey the head 200 in the scanning direction 9 may be hereinafter called as a scanning process. In particular, in the scanning process, the controller 270 outputs the controlling signals V23 to the carriage motor 273 to control the conveyer 210 to convey the head 200 in one way, i.e., rightward or leftward, in the scanning direction 9 for a pass.

The discharging process may be conducted with the atmosphere communication path 221K being closed and while the controlling signals V23 are being output in the scanning process. In particular, while the head 200 is moving above the ink dischargeable range R11, the controller 270 applies the unit of driving signals selected in either S106 (see FIG. 9A) or S114 (see FIG. 9B) to the piezoelectric devices in the head 200. Therefore, the piezoelectric devices may be driven, and the ink may be discharged from the head 200 through the nozzles 203. Accordingly, the image for the pass along the scanning direction may be recorded on the sheet M.

Having finished outputting the driving signal in the pass, the controller 270 stops outputting the controlling signals V23. Moreover, the controller 270 commands the timer 275 to stop measuring. The controller 270 exits S110 thereafter.

In S111, the controller 270 conducts a condition determining process to determine whether a predetermined connection condition is satisfied. In particular, the controller 270 may determine whether the duration measured by the timer 275 reaches a time threshold value. More specifically, the controller 270 may determine whether the duration reached the time threshold value based on whether the controller 270 received the response from the timer 275 on or before S111. If the controller 270 did not receive the response from the timer 275, the controller 270 may determine that the duration does not reach the time threshold value and proceed to S113. If the controller 270 received the response from the timer 275, the controller 270 may determine that the duration reached the time threshold value and proceed to S112.

In S112, the controller 270 conducts a withdrawing process and a connecting process to move the head 200 to reciprocate in the scanning direction 9 between the updated position and the capped position P21. In particular, the controller 270 obtains the updated position of the head 200 based on the signals from the linear encoder 193 (see FIG. 3) and saves the updated position in, for example, the RAM, as a resume position for ink discharging process. Moreover, the controller 270 may move the head 200 rightward, similarly to S105 (see FIG. 9A), to withdraw to the capped position P21 (i.e., withdrawing process). When the head 200 reaches the capped position P21, the valve body 242 may receive the contacting force of the opener member 250 and shifts the atmosphere communication path 221K to the connecting state (i.e., connecting process). Thereafter, the controller 270 moves the head 200 leftward from the capped position P21 to return to the resume position. Furthermore, in S112, the controller 270 issues a reset command form the CPU to initialize the timer 275.

In S113, the controller 270 determines whether an entire image for the sheet M is completely recorded. When the controller 270 determines that the image recording is not completed, the controller 270 proceeds to S114, or when the controller 270 determines that the image recording is completed, the controller 270 proceeds to S115.

In S114, the controller 270 selects another unit of the driving signals for a next pass. Moreover, the controller 270 conducts an intermittent conveying process. In particular, in the intermittent conveying process, the controller 270 outputs the controlling signals V22 to the conveyer motor 272 to control the conveyer roller pair 160 to convey the sheet M in the conveying orientation 4, e.g., frontward, by a distance equal to a single pass in the conveying orientation 4 and controls the conveyer roller pair 160 to stop rotating. The controller 270 proceeds to S109.

In S115, the controller 270 conducts an ejecting process to eject the printed material M. In particular, the controller 270 may output the controlling signals V22 to the conveyer motor 272 to control the conveyer roller pair 160 and the ejection roller pair 170 to eject the printed material M through the sheet outlet 370 at the ejection tray 120.

In S115, further, the controller 270 conducts the remining amount verifying process and, when the controller 270 determines that the surfaces of the inks are above the lower indexes 223L based on signals output from liquid amount sensors (not shown) in the reservoir section 220, the controller 270 sets the empty flag off. On the other hand, when the controller 270 determines that any of the surfaces of the inks is equal to or lower than the lower indexes 223L, the controller 270 determines that the amount of at least one of the inks in the reservoir section 220 reaches an injection threshold amount and sets the empty flag on.

In S116, the controller 270 determines whether image recording to record the entire images on the sheet M is completed. When the controller 270 determines that the image recording is not completed, the controller 270 proceeds to S104 (see FIG. 9A); or when the controller 270 determines that the image recording is completed, the controller 270 ends the image recording process shown in FIGS. 9A-9B.

[Ink Injecting Process (S117-S119)]

In S117 (see FIG. 9A), the controller 270 conducts an ink injecting process. In particular, the controller 270 conducts a moving process, in which the controller 270 moves the head 200 from the updated position to the capped position P21, similarly to S106. The controller 270 may output an audio message or an image alerting the user that at least one of the ink reservoir chambers 220B needs to be refilled with the ink. The user recognizing the alert may access the reservoir section 220 and open the lid 230, following a predetermined procedure for refiling. The user may attach a bottle (not shown) containing the ink to the injection port 224A and pour the ink in the bottle to the ink reservoir chamber 220B until the surface of the ink reaches the upper index 223U. In S118, the user may input a notice indicating that the ink reservoir chamber 220B is refilled through, for example, an operation interface (not shown) in the printer 100. In response to the user's input, in S119, the controller 270 initializes the counter value to zero (0), sets the empty flag off, and resets the timer 275. Thereafter, the controller 270 proceeds to S105.

[Benefits]

In the embodiment described above, during the intermittent conveying process, the sheet M being conveyed in the linear path P2 may contact the nozzles 203 of the head 200, and the inks in the head 200 may leak out to stain the sheet M. In this occasion, however, after S109, the atmosphere communication path 221K is placed in the disconnecting state. Therefore, the negative pressure in the inner space 220A of the reservoir section 220 may be maintained. Accordingly, leakage of the inks that may occur during the intermittent conveying process or the discharging process may be restrained from growing. Meanwhile, the volume Vb of the air portion is predetermined based on the formula (1) and the formula (2) described above. In other words, the volume Vb of the air portion is controlled to satisfy the formula (1) and the formula (2). Moreover, the connecting process in S112 may be conducted on condition that the connection condition is satisfied in S111 (see FIG. 9B). This allows the air pressure in the inner space 220A, which has become negative due to the discharging process, to return to the atmospheric pressure, i.e., 1 atm. Therefore, the inks may form the menisci in the nozzles 203 preferably even if the volume of the air portion changes during the discharging process.

According to the embodiment described above, the user may visually recognize the surface levels of the inks in the ink reservoir chambers 220B easily with reference to the upper indexes 223U. Therefore, the user may pour the ink into the ink reservoir chamber 220B and stop pouring at the level of the upper index 223U easily. Accordingly, while the inks may be reduced from the preferably refilled amounts, the inks may form the menisci in the nozzles 203 preferably even if the volume of the air portion changes during the discharging process.

According to the embodiment described above, the air chamber 220C is located at the upper position with respect to the ink reservoir chambers 220B. Therefore, the inks may not enter the air chamber 220C easily, and, without the inks, the air may be drawn to the air chambers 220C easily and sufficiently in the connecting process.

According to the embodiment described above, the air chamber 220C is located at the upper position with respect to the lower ends of the ink supplying paths 224B. Therefore, again, the inks may not enter the air chamber 220C easily, and, without the inks, the air may be drawn to the air chambers 220C easily and sufficiently in the connecting process.

According to the embodiment described above, the reservoir section 220 has the plurality of ink reservoir chambers 220B and the atmosphere communication path 221K connecting the inside and the outside of the ink reservoir chambers 220B. The switching assembly may switch the states of the atmosphere communication path 221K between the connecting state, in which the plurality of ink reservoir chambers 220B are collectively connected to the outside, and the disconnecting state, in which the plurality of ink reservoir chambers 220B are collectively disconnected from the outside. Therefore, the controller 270 may be released from burdens to switch states of the ink reservoir chambers 220B individually.

### MODIFIED EXAMPLES

Although an example of carrying out the invention has been described, those skilled in the art will appreciate that there are numerous variations and permutations of the liquid discharging apparatus that fall within the spirit and the scope of the invention as set forth in the appended claims. It is to be understood that the subject matter defined in the appended claims is not necessarily limited to the specific features or act described above. Rather, the specific features and acts described above are disclosed as example forms of implementing the claims. In the meantime, the terms used to represent the components in the above embodiment may not necessarily agree identically with the terms recited in the appended claims, but the terms used in the above embodiment may merely be regarded as examples of the claimed subject matters. Described below will be modified examples of the present embodiment.

### First Modified Example (First Modified Example of Reservoir Section 220)

As a first modified example of the reservoir section 220, at least a part of the outer wall 221 may be deformable by the pressure change of the air portion in the reservoir section 220. For example, a part of the outer wall 221 may be made of a resin film, which may be resiliently deformed by a pressure change, while another part of the outer wall 221 may be made of resin, in a form thicker than the resin film, which is not deformable by the pressure change.

According to the first modified example, when the pressure of the air portion decreases, the volume of the air portion may be reduced due to the deformation of the deformable part of the outer wall 221. Therefore, the negative pressure in the air portion due to the discharging process may be restrained from growing. As a result, a number of times to conduct the connecting process may be lowered, and a number of images that may be recorded per unit time, i.e., ipm, may be increased.

### Second Modified Example (Second Modified Example of Reservoir Section 220)

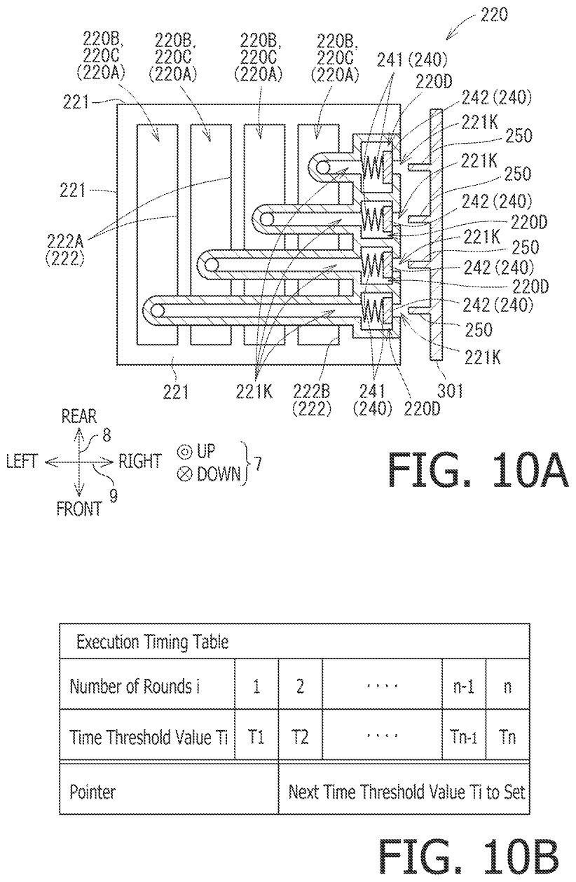

In the embodiment described above, the air chamber 220C is not divided into a plurality of sections. However, for example, as shown in FIG. 10A, the inner space 220A in the reservoir section 220 may be divided by three (3) vertical divider walls 222A into four (4) sections, each of which has the ink reservoir chamber 220B and the air chamber 220C. In other words, the reservoir section 220 may include four (4) ink reservoir chambers 220B, four (4) air chambers 220C, and four (4) air portions. In this arrangement, each ink reservoir chamber 220B may be connected with the outside of the reservoir section 220 through one of the four air portions in four (4) individual atmosphere communication paths 221K individually. Moreover, to each of the air chambers 220C, an individual valve placement space 220D may be arranged at a rightward position with respect to the air chamber 220C. In each of the valve placement spaces 220D, the valve unit 240 may be arranged. The frame 301 may have four (4) opener members 250, each of which corresponds to one of the four valve units 240. As the head 200 moves to the capped position P21, the opener members 250 may switch the respective valve units 240 to the connecting state collectively and substantially simultaneously, and as the head 200 leaves the capped position P21, the opener members 250 may switch the respective valve units 240 to the disconnecting state.

### Third Modified Example (Modified Example of Image Recording Process)

As a third modified example, the controller 270 may set a time threshold value Ti (see FIG. 10B) being a variable value to the timer 275. A time threshold value T1 may be set to the timer 275 at the time when the printer 100 is shipped out of a factory or when the printer 100 is powered on.

The EEPROM may store an execution timing table as shown in FIG. 10B. The execution timing table may define the time threshold value Ti, i.e., an execution timing to conduct the connecting process (S112), for each round i of the connecting process. The sign i represents a natural number such as 1, 2, . . . , n−1, n. In other words, the execution timing table defines time threshold values T1, T2, . . . , Tn−1, Tn corresponding to the rounds 1, 2, . . . , n−1, n, respectively. The time threshold value T1 may be, for example, 30 seconds. The time threshold values T2, . . . , Tn may be greater than the time threshold values T1, . . . , Tn−1, respectively. Optionally, however, the time threshold values T2, . . . , Tn may not necessarily be greater than the time threshold values T1, . . . , Tn−1, respectively, as long as at least one of the time threshold values T2, . . . , Tn is greater than the time threshold value T1.

Moreover, as shown in FIG. 10B, the EEPROM may have a pointer indicating a next time threshold value Ti to be set in the timer 275. At the time when the printer 100 is shipped out of the factory, the time threshold value T2 may be set in the pointer.

The controller 270 may, after initializing the timer 275 in S112 (see FIG. 9B), set the time threshold value Ti indicated by the pointer to the timer 275. Moreover, the controller 270 may update the time threshold value Ti having been indicated by the pointer with a new time threshold value Ti+1. When a number of rounds i is n (i=n), however, the controller 270 may update the time threshold value Ti having been indicated by the pointer with the time threshold value T1.

The controller 270 may, after initializing the timer 275 in S119 (see FIG. 9A), set the time threshold value T1 indicated by the pointer to the timer 275.

### Benefits by Third Modified Example

According to the process shown in FIGS. 9A-9B, the controller 270 may repeat the connecting process (S112) and the disconnecting process (S109) alternately for a plurality of rounds. In the third modified example, the controller 270 may set the time threshold value T1 for the timer 275 in accordance with the execution timing table (see FIG. 10B); thereby a disconnecting period, which is between the disconnecting process in a round later than a first round and the connecting process immediately after the disconnecting process in the round later than the first round, may be longer than a disconnecting period, which is between the disconnecting process in the first round and the connecting process immediately after the disconnecting process in the first round. Therefore, a number of times the switching assembly conducts the withdrawing process and the connecting process while the image is being recorded may be reduced as the image recording lasts longer.

Moreover, in the case where at least one of the time threshold values T2, . . . , Tn is greater than the time threshold value T1, the number of times the switching assembly conducts the withdrawing process and the connecting process while the image is being recorded may still be reduced in comparison to the embodiment described earlier.

In the third modified example, moreover, the timer 275 may be set at the time threshold value T1 in S119, which is after the ink is injected into the ink reservoir chamber 220B. Therefore, the connecting process (S112) to be conducted for the first time after injecting the ink may be conducted in response to the duration reaching the time threshold value T1. In other words, after injecting the ink in the ink reservoir chamber 220B, the controller 270 may conduct the connecting process at the execution timing of the first round. Therefore, even if the volume of the air portion changes due to the discharging process after refilling, the inks may form the menisci in the nozzles 203 preferably.

### Fourth Modified Embodiment (Modified Example of Image Recording Process)

In the embodiment describe earlier, the controller 270 conducts the connecting process based on the duration measured by the timer 275. Alternatively, the controller 270 may have an air pressure sensor to detect the air pressure of the air portion in place of the timer 275. With the air pressure sensor, the controller 270 may not start timing by the timer 275 in S109, stop timing by the timer 275 in S110, or reset the timer 275 in S112, S119. Rather, the controller 270 may determine the amount of air pressure having been changed by subtracting the air pressure detected by the air pressure sensor in S110 from one atmosphere, and, in S111, determine whether the amount of change in the air pressure has reached ΔP being the air pressure threshold. If the controller 270 determines that the amount of change in the air pressure has reached ΔP in S111, the controller 270 may proceed to S112, and if not, the controller 270 may proceed to S113.

### Fifth Modified Example (Modified Example of Switching Assembly)

The switching assembly may not necessarily have the conveyer 210, the valve unit 240, and the opener member 250 but may consist of, for example, an electromagnetic valve. The electromagnetic valve may include a solenoid and a valve body made of, for example, iron. The controller 270 may apply current to the solenoid, and thereby the valve body may be attracted to the solenoid. Accordingly, the atmosphere communication path 221K may be shifted to the connecting state. On the other hand, when the controller 270 does not apply current to the solenoid, the valve body may separate from the solenoid, and the atmosphere communication path 221K may be shifted to the disconnecting state.

### Sixth Modified Example (Modified Example of Opener Member 250)

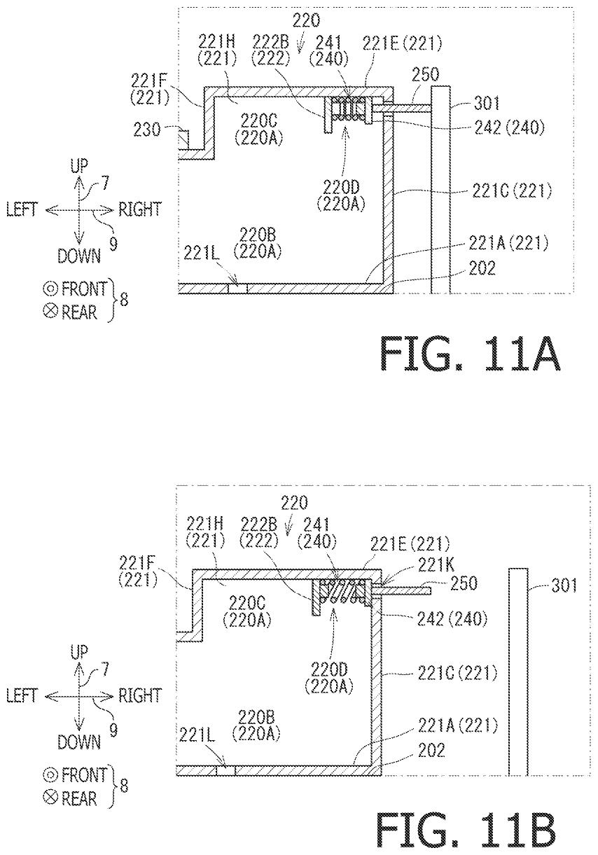

In the embodiment described above, the opener member 250 protrudes from the frame 301 toward the valve body 242 (see, for example, FIG. 4). However, alternatively, the opener member 250 may protrude from the valve body 242 outward from the outer wall 221 through the atmosphere communication path 221K, as shown in FIGS. 11A-11B. In this arrangement, the opener member 250 may contact the frame 301 as the head 200 moves toward the capped position P21, and thereby the valve body 242 may shift the atmosphere communication path 221K to the connecting state (see FIG. 11A). On the other hand, the opener member 250 may separate from the frame 301 as the head 200 leaves the capped position P21, and thereby the valve body 242 may shift the atmosphere communication path 221K to the disconnecting state (see FIG. 11B).

### Seventh Modified Example (Modified Example of Cap 260 and Lift Assembly 261)

In the embodiment described above, the lift assembly 261 may move between the capping position P31 and the uncapping position P32 by the driving force transmitted from the lift motor 274. Alternately, the cap 260 and the lift assembly 261 may be moved by use of the carriage 190 moving in the scanning direction 9. While the cap 260 and the lift assembly 261 are in known configurations, in the following paragraphs, description of those will be simplified.

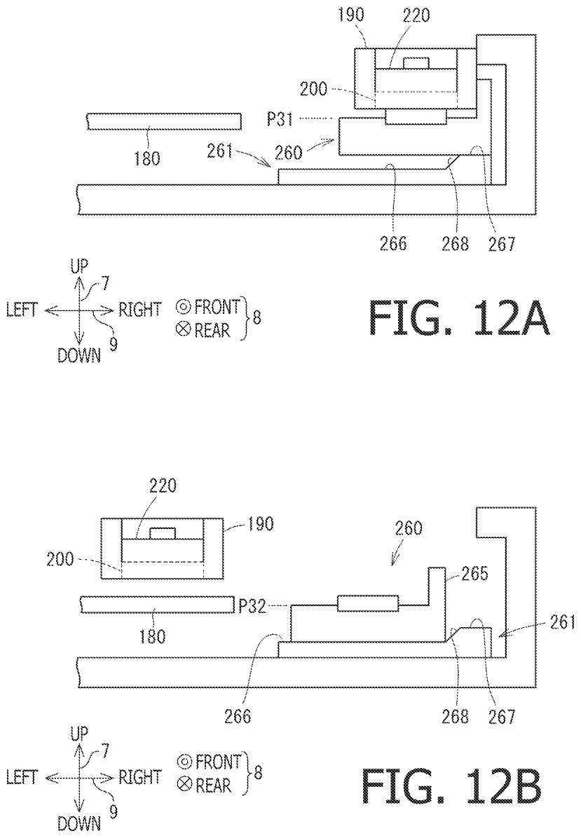

The cap 260 may have a contact member 265, as shown in FIG. 12B, which may contact the carriage 190 moving in the scanning direction 9. The cap 260 may move in the scanning direction 9 as the contact member 265 is pushed by the carriage 190.

The lift assembly 261 may have a first guiding surface 266, a second guiding surface 267, and an inclined surface 268. The first guiding surface 266 may spread in the front-rear direction 8 and the widthwise direction 9 at a position rightward with respect to the platen 180 and support the cap 260 at the uncapping position P32. The second guiding surface 267 may spread in the front-rear direction 8 and the widthwise direction 9 at a position rightward with respect to the first guiding surface 266 and support the cap 260 at the capping position P31. The inclined surface 268 is a plain surface connecting a rightward end of the first guiding surface 266 and a leftward end of the second guiding surface 267.

The cap 260 moving in the scanning direction 9 may move between the first guiding surface 266 and the second guiding surface 267 via the inclined surface 268. Therefore, when the cap 260 is supported by the second guiding surface 267 (see FIG. 12A), the cap 260 may cover the nozzles 203 (not shown in FIGS. 12A-12B) at the capping position P31. On the other hand, when the cap 260 is supported by the first guiding surface 266 (see FIG. 12B), the cap 260 may be located at the uncapping position P32.

### Eighth Modified Example (Alternative Examples of ΔV)

In the embodiment described above, the sign ΔV represents the change in the volume of the air portion caused by the change in the volume of the inks in the reservoir section 220 when the inks of the predetermined volume were discharged at the sheet M under the specific condition to record the specific image in the discharging process. However, optionally, ΔV may be determined in the following manner. The feeder tray 110 may be adaptable to store different-sized sheets M on the bottom 111. In other words, the feeder tray 110 may store sheets M of one of the different sizes. For example, ΔV may be equal to or greater than a volume of the ink that may be discharged from the head 200 for recording a pass of a specific image (e.g., a solid image) on a specific sheet M under a specific ink amount condition where an amount of the ink per unit time discharged from the head 200 is a maximum amount. For another example, ΔV may be equal to or greater than a volume of the ink that may be discharged from the head 200 for recording an image in an entire printable area on one side of the specific sheet M under the specific ink amount condition where the amount of the ink per unit time discharged from the head 200 is the maximum amount. The specific sheet M may be a sheet M of a largest size among the plurality of different-sizes sheets M storable in the feeder tray 110.

### Eighth Modified Example (Other Items)

For example, the printer 100 may have a plurality of feeder trays 110. Each of the plurality of feeder trays 110 may store sheets M in a different size. The controller 270 may conduct the image recording process (see FIGS. 9A-9B) described earlier with the sheets M in a size selected by a user's operation through an operation panel, which is not shown. In this arrangement, the specific sheet M may be a sheet M in a largest size selectable by the user's operation among the different-sized sheets M storable in the plurality of feeder trays 110.

### MORE EXAMPLES

For another example, the liquid discharging apparatus may not necessarily be limited to the printer 100 as described above but may be a multifunction peripheral machine, a copier, and a facsimile machine. The multifunction peripheral machine may be an apparatus equipped with a plurality of functions among a printing function, a copying function, and a facsimile transmitting/receiving function.

For another example, the printer 100 may have a line-formation printing head in place of the serial-formation printing head 200 when the switching assembly consists of an electromagnetic valve. In the printer 100 with the line-formation printing head 200, the head 200 may not be conveyed in the scanning direction 9 but may stay still at a position above the platen 180.

For another example, the printer 100 may not necessarily be limited to the on-carriage printer but may be a so-called off-carriage printer, in which the reservoir section 220 may not be mounted on the carriage 190 but may be located separately from the carriage 190. When the printer 100 is the off-carriage printer, the reservoir section 220 may not move in the widthwise direction 9 inside the housing 300; therefore, the switching assembly may preferably consist of an electromagnetic valve.

For another example, the reservoir section 220 may not necessarily have the plurality of ink reservoir chambers 220B to store the plurality of different-colored inks but may have a single ink reservoir chamber 220B to store an ink in a single color, e.g., black. In other words, the reservoir section 220 may not have the three vertical divider walls 222A. In this arrangement, again, the volume Vb of the air portion may still be determined to satisfy the formula (1) and the formula (2).

Meanwhile, if the reservoir section 220 has solely a single reservoir chamber 220B to store a single-colored ink alone, the specific image may be the monochrome pattern image described in ISO/IEC 24734, established by the International Organization for Standardization. The specific condition may be the same as that in the embodiment described above.

For another example, the reservoir section 220 may not necessarily be the ink tank fixed to the head 200 but may be a cartridge detachably attached to the head 200.

What is claimed is:

1. A liquid discharging apparatus, comprising:
a head having nozzles, the head being configured to discharge liquid through the nozzles;
a reservoir section, having:
a liquid reservoir chamber configured to store the liquid; and
an atmosphere communication path connecting inside and outside of the liquid reservoir chamber through an air portion in the reservoir section,
a liquid flow path connecting the head and the liquid reservoir chamber for the liquid to flow therein;
a switching assembly configured to switch states of the atmosphere communication path between a connecting state, in which the inside and the outside of the liquid reservoir chamber are connected, and a disconnecting state, in which the inside and the outside of the liquid reservoir chamber are disconnected; and
a controller configured to:
control the switching assembly in a disconnecting process to switch the states of the atmosphere communication path from the connecting state to the disconnecting state; and
control the head in a discharging process to discharge the liquid through the nozzles after the disconnecting process,
wherein a volume Vb of the air portion is set to satisfy formulas (1) and (2):
Vb=(Po+ΔP)*ΔV/ΔP (1); and
ΔP≤Pm (2),
wherein Po represents one atmosphere,
wherein ΔV represents a change in the volume of the air portion due to a change in a volume of the liquid caused by discharging a predetermined amount of the liquid in the discharging process,
wherein ΔP represents a change in pressure of the air portion according to the change in the volume of the liquid in the discharging process, and
wherein Pm represents a pressure resistance of menisci formed with the liquid in the nozzles.

2. The liquid discharging apparatus according to claim 1,
wherein ΔV represents the change in the volume of the air portion due to the change in the volume of the liquid caused by discharging the predetermined amount of the liquid in the discharging process to record a specific image on a sheet under a specific condition.

3. The liquid discharging apparatus according to claim 2,
wherein the specific image is a pattern image defined by the International Organization for Standardization, and
wherein the specific condition is recording the pattern image continuously for a specific length of time.

4. The liquid discharging apparatus according to claim 3,
wherein the specific length of time is 30 seconds,
wherein the pattern image is a multicolor pattern image,
wherein the specific condition is recording the pattern image continuously for 30 seconds in a standard mode defined by the International Organization for Standardization on the sheet in A4-size.

5. The liquid discharging apparatus according to claim 4,
wherein the controller is configured to control the switching assembly in a connecting process to switch the states of the atmosphere communication path from the disconnecting state to the connecting state in response to duration of the discharging process reaching 30 seconds.

6. The liquid discharging apparatus according to claim 1,
wherein the predetermined amount is an amount equal to or greater than a volume of the liquid to be discharged from the head for recording a pass of an image on a specific sheet under a condition where an amount of the liquid per unit time discharged from the head is a maximum amount.

7. The liquid discharging apparatus according to claim 1,
wherein the predetermined amount is an amount equal to or greater than a volume of the liquid to be discharged from the head for recording an image in an entire printable area on one side of a specific sheet under a condition where an amount of the liquid per unit time discharged from the head is a maximum amount.

8. The liquid discharging apparatus according to claim 6, further comprising a sheet storage,
wherein the specific sheet is a sheet in a largest size storable in the sheet storage.

9. The liquid discharging apparatus according to claim 6, further comprising a sheet storage,
wherein the specific sheet is a sheet in a largest size selectable by a user's operation among different-sized sheets storable in the sheet storage.

10. The liquid discharging apparatus according to claim 1,
wherein the controller is configured to control the switching assembly in a connecting process to switch the states of the atmosphere communication path from the disconnecting state to the connecting state in response to an amount of the change in the pressure of the air portion by the discharging process reaching ΔP.

11. The liquid discharging apparatus according to claim 1,
wherein the reservoir section has an index indicating a surface level of a maximum amount of the liquid storable in the liquid reservoir chamber, and
wherein the volume Vb is a volume of the air portion when the surface level of the liquid is at a substantially same position as the index.

12. The liquid discharging apparatus according to claim 1,
wherein the reservoir section has an air chamber located at an upper position with respect to the liquid reservoir chamber, the air chamber being configured to store at least a part of the air portion.

13. The liquid discharging apparatus according to claim 12,
wherein the reservoir section has a liquid supplying path connecting the inside and the outside of the liquid reservoir chamber, and
wherein the air chamber is located at an upper position with respect to a lower end of the liquid supplying path.

14. The liquid discharging apparatus according to claim 1,
wherein the reservoir section further has an outer wall, the outer wall delimiting the liquid reservoir chamber from the outside, and
wherein a part of the outer wall is deformable by a pressure change inside the reservoir section.

15. The liquid discharging apparatus according to claim 10,
wherein the controller is, after starting to record an image on a sheet in the discharging process, configured to repeat the connecting process and disconnecting process alternately for a plurality of rounds, and
wherein a disconnecting period, which is between the disconnecting process in a round later than a first round and the connecting process immediately after the disconnecting process in the round later than the first round, is longer than a disconnecting period, which is between the disconnecting process in the first round and the connecting process immediately after the disconnecting process in the first round.

16. The liquid discharging apparatus according to claim 15,
wherein the controller has a memory storing an execution timing to conduct the connecting process for each of the plurality of rounds, and
wherein the controller is configured to conduct the connecting process at the execution timing corresponding to the first round after the liquid is injected into the liquid reservoir chamber.

17. The liquid discharging apparatus according to claim 1,
wherein the liquid reservoir chamber includes a plurality of liquid reservoir chambers, and
wherein the atmosphere communication path connects inside and outside of the plurality of liquid reservoir chambers through the air portion.

18. The liquid discharging apparatus according to claim 1,
wherein the liquid reservoir chamber includes a plurality of liquid reservoir chambers,
wherein the atmosphere communication path includes a plurality of atmosphere communication paths, each of which connects inside and outside of each one of the plurality of liquid reservoir chambers through each one of a plurality of air portions, and
wherein the switching assembly is configured to switch states of the plurality of atmosphere communication paths collectively between a connecting state, in which the inside and the outside of the plurality of liquid reservoir chambers are connected, and a disconnecting state, in which the inside and the outside of the plurality of liquid reservoir chambers are disconnected.
